(19) United States
(12) Patent Application Publication
(10) Pub. No.: US 2010/0146459 A1
(43) Pub. Date: Jun. 10, 2010

(54) Apparatus and Method for Influencing Application Window Functionality Based on Characteristics of Touch Initiated User Interface Manipulations

(76) Inventor: MIKKO REPKA, OULU (FI)

Correspondence Address: Hollingsworth & Funk, 8500 Normandale Lake Blvd., Suite 320, Minneapolis, MN, 55437, US

(21) Appl. No.: 12/330,142

(22) Filed: Dec. 8, 2008

(51) Int. Cl. G06F 3/033; G06F 3/041

(52) U.S. Cl. 715/863; 345/173

(57) ABSTRACT

Apparatuses and methods for presenting an application window on a touch sensitive screen of a mobile device, the application window configured to facilitate user interaction with an application and with a plurality of touch activatable items displayable in a predetermined manner within the application window. A first long tap is detected having a first predetermined duration within the application window and invoking, in response to detecting the first long tap, a first mode of the application window that enables a first type of behavior of one or more of the touch activatable items. At a touch sensitive screen location other than a location within the application window, a second long tap having a second predetermined duration is detected and, in response to the second long tap, a second mode is invoked that influences behavior of one or more of the touch activatable items within the application window.

### FIELD OF THE INVENTION

This invention relates in general to mobile devices that utilize a touch sensitive user interface, and more particularly to apparatuses and methods for facilitating efficient user interaction with items of an application window presented on a touch sensitive user interface.

### BACKGROUND OF THE INVENTION

With the introduction of mobile devices that support a multiplicity of functions, it has become increasingly more difficult to design a user interface that enables the user to access the many types of functions and applications available in small hand held devices. It is a particular challenge to present a simple and efficient means by which the user can communicate with the device for browsing, selecting, and operating amidst the wide array of choices. The user interface generally consists of a keypad for entering data and commands and a display screen for presenting information relating to operation of the selected function. The touch sensitive screen has become very useful in combining the function of both display and keypad in multifunction devices. The convenience offered by touch sensitive user interfaces often comes at the cost of increasing the number of touch operations needed to effect even relatively simple tasks, particularly those that are commonly and repeatedly used. Accordingly, there is a need for, among other things, simplifying the manner in which commonly used functions are effected using a touch sensitive user interface of a mobile device and enhancing functionality of touch activated user interface features. The present invention fulfills these and other needs, and offers numerous advantages over the prior art.

### SUMMARY

To overcome limitations described above, and to overcome other limitations that will become apparent upon reading and understanding the present specification, the present invention discloses systems, apparatuses and methods for enhancing user interaction with one or more applications implemented by a mobile device using a touch sensitive user interface.

In accordance with one embodiment of the invention, a method is provided for presenting an application window on a touch sensitive screen of a mobile device. The application window is configured to facilitate user interaction with an application and a number of touch activatable items displayable in a predetermined manner within the application window. The method involves detecting a first long tap having a first predetermined duration within the application window and invoking, in response to detecting the first long tap, a first mode of the application window that enables a first type of behavior of one or more of the touch activatable items. The method further involves detecting, at a touch sensitive screen location other than a location within the application window, a second long tap having a second predetermined duration and invoking, in response to the second long tap, a second mode that influences behavior of one or more of the touch activatable items within the application window.

According to one embodiment, a method of the invention involves detecting a tap within the application window and identifying the tap as a short tap in response to determining that the tap has a duration shorter than the predetermined duration of the first long tap. In response to detecting the short tap, a third mode is invoked that enables a third type of behavior of one or more of the touch activatable items. For example, the third mode may enable movement of one or more of the activatable items in an incremental manner in response to detecting each of the short taps, while the first mode enables movement of one or more of the activatable items in a continuous manner in response to detecting each of the first long taps.

In accordance with a further embodiment, an apparatus of the invention includes a mobile device and a user interface provided on the mobile device that comprises a touch sensitive screen. A touch detection module is coupled to the touch sensitive screen and configured to detect a touch applied to the touch sensitive screen and determine a location of the touch the touch sensitive screen. The touch detection module is configured to detect a first long tap within an application window of the touch sensitive screen having a first predetermined duration and detect, at a touch sensitive screen location other than a location within the application window, a second long tap having a second predetermined duration. A processor is coupled to the user interface and the touch detection module. The processor is configured to display a plurality of touch activatable items associated with a processor controlled application in a predetermined manner within the application window. For example, the processor may be configured to facilitate user interaction with a processor controlled application and with a plurality of touch activatable items displayable in a predetermined manner within the application window. The processor is further configured to activate, in response to the touch detection module detecting the first long tap, a first mode of the application window that enables a first type of behavior of one or more of the touch activatable items and activate, in response to the touch detection module detecting the second long tap, a second mode that influences behavior of one or more of the touch activatable items within the application window.

According to one embodiment, the processor is configured to detect a tap within the application window, identify the tap as a short tap in response to determining that the tap has a duration shorter than the predetermined duration of the first long tap, and activate, in response to detecting the short tap, a third mode that enables a third type of behavior of one or more of the touch activatable items. For example, in the third mode, the processor may be configured to enable movement of one or more of the activatable items in an incremental manner in response to the touch detection module detecting each of the short taps and, in the first mode, the processor may be configured to enable movement of one or more of the activatable items in a continuous manner in response to the touch detection module detecting each of the first long taps.

In accordance with another embodiment, a computer-readable storage medium has instructions executable by a processor of a mobile device for performing steps comprising presenting an application window on a touch sensitive screen provided on a mobile device, the application window configured to facilitate user interaction with an application and with a plurality of touch activatable items displayable in a predetermined manner within the application window, detecting a first long tap having a first predetermined duration within the application window, invoking, in response to detecting the first long tap, a first mode of the application window that enables a first type of behavior of one or more of the touch activatable items, detecting, at a touch sensitive screen location other than a location within the application window, a second long tap having a second predetermined duration, and invoking, in response to the second long tap, a second mode that influences behavior of one or more of the touch activatable items within the application window.

The above summary is not intended to describe every embodiment or implementation of the present invention. Rather, attention is directed to the following figures and description which set forth representative embodiments of the invention.

### BRIEF DESCRIPTION OF THE DRAWINGS

The invention is described in connection with the embodiments illustrated in the following diagrams.

FIG. 1 is a block diagram of a mobile device that incorporates a touch sensitive screen and a programmed processor for altering user interface functionality based on detected touch characteristics according to an embodiment of the invention;

FIG. 2 is a flow diagram showing various processes implementable by a mobile device that incorporates a touch sensitive screen and a programmed processor for altering user interface functionality based on detected touch characteristics according to an embodiment of the invention;

FIG. 3A is a flow diagram showing various processes implementable by a mobile device that incorporates a touch sensitive screen and a programmed processor for altering user interface functionality in response to detecting long taps within and outside of an application window, respectively, according to an embodiment of the invention;

FIG. 3B is a flow diagram showing various processes implementable by a mobile device that incorporates a touch sensitive screen and a programmed processor for altering user interface functionality in response to detecting short and long taps within an application window and detecting long taps outside the application window according to an embodiment of the invention;

FIG. 4 is a plot of touch duration versus touch signal amplitude and detection windows for detecting long taps within and outside of an application window, respectively, and, optionally, short taps within the application window according to an embodiment of the invention;

FIG. 5 shows an embodiment of an application window presented on a touch sensitive screen of a mobile device, and touch detection implemented in the application window employing several of the detection techniques shown in FIG. 4;

FIG. 6 is a flow diagram showing various processes for detecting long taps within and outside of an application window, respectively, and short taps within the application window according to another embodiment of the invention;

FIG. 7A illustrates an application window representative of a widget presented on a touch sensitive screen and a multiplicity of activatable items that can be selected and/or manipulated in response to detecting different types of taps applied to the application window by a user according to an embodiment of the invention;

FIG. 7B illustrates the application window shown in FIG. 7A, and further shows a location of a touch outside of the application window that, when detected, initiates an alteration to functionality within the application window according to an embodiment of the invention;

FIG. 7C shows the touch sensitive screen illustrated in FIGS. 7A and 7B, and invocation of a ‘view edit’ mode in response to long tap detected at a location of the touch sensitive screen outside of the application window according to an embodiment of the invention;

FIG. 8 depicts a representative mobile device that incorporates a touch sensitive screen and a programmed processor capable of implementing operations in accordance with the invention; and

FIG. 9 depicts a representative touch sensitive screen and associated components for use in a mobile device that incorporates a programmed processor capable of implementing operations in accordance with the invention.

### DETAILED DESCRIPTION OF EMBODIMENTS OF THE INVENTION

In the following description, reference is made to the accompanying drawings which form a part hereof, and in which is shown by way of illustration various representative manners in which the invention may be practiced. It is to be understood that other embodiments may be utilized, as structural and/or operational changes may be made without departing from the scope of the present invention.

Generally, the present invention provides for enhanced user interaction with items of an application window presented on a touch sensitive user interface. Embodiments of the invention are directed to detecting various types of user touches and altering behavior within an application window based on detected user touches. A touch discrimination algorithm is preferably employed to distinguish between different types of user touches, such as short taps and long taps. Touch detection logic is employed to implement desired alterations to application window behavior based on user touch attributes, including type of touch, location of the touch, and timing of the touch. Touches detected within the application window and outside of the application window preferably influence application window behavior in a predetermined manner.

In general, different kinds of taps applied to a touch sensitive user interface can be detected for activating different types of modes, functions, and behaviors. Generally, most activatable items presented on the touch sensitive user interface (e.g., shortcuts, widgets etc.) can be activated when the user presses an implement (e.g., finger, pen, stylus, etc.) down on a touch sensitive screen (i.e., touch down) and lifts the implement up or off the screen (i.e., lift off). The user may move the pressed-down implement along the screen's surface and cancel an action by dragging the implement to a certain screen area or select another action (e.g., button, icon, etc.) by moving the implement to that area and lifting the implement up. Sometimes, according to various embodiments, the length of time the user can hold the implement down on the screen's surface is “constrained” by the activation of a secondary function (e.g., selection list) and this may be referred to as a ‘long tap.’

Then, there are certain activatable items that are activated when the user presses them (i.e., the activation occurs at finger touch down, not lift off) and holding down the activatable item performs a ‘key repeat’ function. This functionality is typically used mainly with input methods (e.g., virtual keyboard keys, delete/backspace, etc.) and scrollers (e.g., move left/right arrows, etc.). Here, the long tap does not activate any secondary action, unless the key repeat (e.g., faster scrolling/deleting, etc.) is seen as such. This feature may be referred to as ‘tap & hold’. Advantageously, embodiments of the present invention can combine both scenarios.

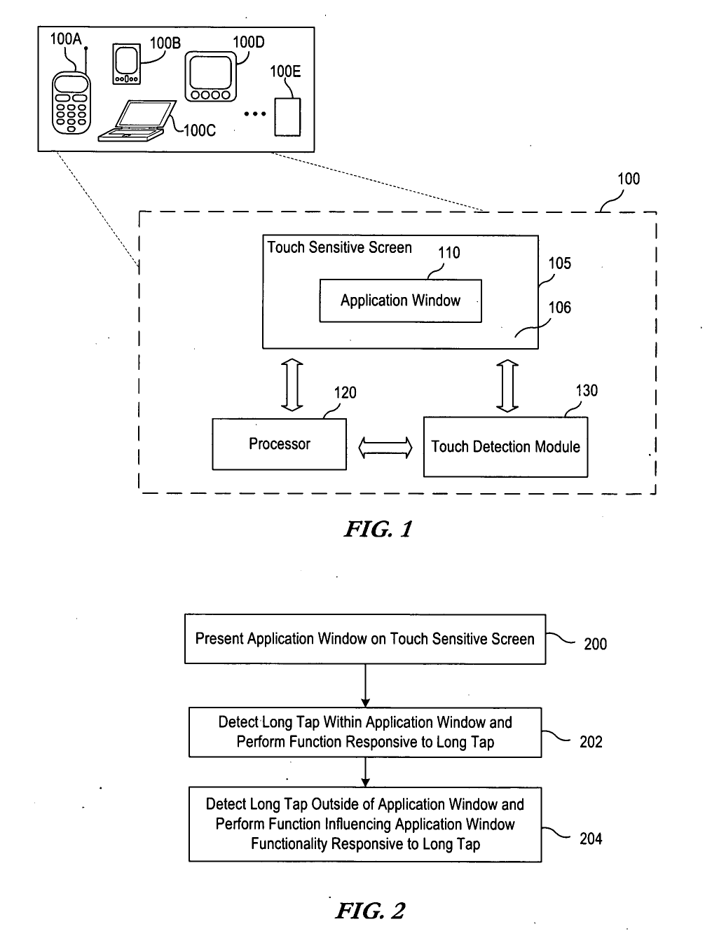

FIG. 1 generally illustrates a representative block diagram of a mobile device that incorporates a touch sensitive user interface that facilitates user interaction with an application presented in an application window of the user interface. The user interface is configured to detect a location and a duration of user touches or taps, and modify behavior of application window functionality based on tap location and duration. The user interface may also be configured to detect a delay between taps of the same type and/or differing type, and modify behavior of application window functionality based on detection of a tap within or beyond a delay period. Application window functionality may be modified based on one or more of the type of detected tap, sequence of detected taps and/or tap type, absence or occurrence of a detected tap during a delay period, and whether a tap of a particular type occurred during a delay period.

For example, taps having disparate characteristics applied within an application window may invoke different functionality within the application window. When detected outside of the application window, a tap having a particular characteristic can influence functionality within the application window, such as by invoking a mode of application window operation or altering a behavior of an item, feature, or item/feature presentation within the application window.

The embodiment of FIG. 1 relates to mobile devices that facilitate user interaction with the mobile devices via a touch sensitive surface, such as a touch sensitive panel or screen. Representative mobile devices 100 in accordance with embodiments of the invention include mobile phones 100A, personal digital assistants 100B, laptop or other portable computing devices 100C, portable digital music players 100D (e.g., MP3 players), and/or any other 100E mobile devices capable of supporting a touch sensitive user interface. Such other mobile devices may include a portable game device, a portable camera/camcorder, a portable audio/video device, a portable AM/FM/Digital radio device, a portable television device, a wrist watch, etc.

The representative mobile device 100 incorporates a user interface that includes a touch sensitive screen 105 which is situated above or integrated with a display 106. A typical touch sensitive screen 105 employs a sheet of glass with a conductive coating such as indium tin oxide with four terminal connections, one at each corner. The touch sensitive screen 105 may also be a capacitive or resistive touch sensitive screen with a pattern of electrodes made of conductive material. In another configuration, the touch sensitive screen 105 may incorporate a surface acoustic wave sensor that uses ultrasonic waves that pass over a touch sensitive screen or panel 105. When the panel is touched, a portion of the surface acoustic wave is absorbed. A change in the ultrasonic waves registers the position of the touch event. The touch sensitive screen 105 may alternatively have a strain gauge configuration, in which a screen is spring-mounted on the four corners of the touch sensitive screen substrate and strain gauges are used to determine deflection when the screen is touched. Displacement along the vertical plane (Z-axis) can also be measured.

Other touch sensitive screen technologies are contemplated, including dispersive signal technology that operates on bending wave (e.g., lamb waves), and acoustic pulse recognition, which uses more than two piezoelectric transducers located at various positions of the touch sensitive screen and circuitry to convert mechanical energy of a touch into an audio file, and then compare this audio file to a preexisting audio profile for every position on the screen.

In the context of a capacitive touch sensitive screen 105, a finger of a user (or a stylus) can draw or inject current at the point of contact. The current can then distribute to the touch panel terminals in a proportionate manner relative to the location of the point of contact. The accuracy of the touch sensitive screen thus depends on how well the division of current among the terminals represents the contact location. To help correlate point of contact signals with correct position data, touch sensitive screens are generally calibrated. Calibration typically takes place during manufacturing, and may be repeated (manually or automatically) during the service life of the touch sensitive screen 105.

The touch sensitive screen 105 is responsive to user touches, allowing the user to interact with the mobile device 100 by way of taps applied to specific locations of the touch sensitive screen 105 at particular times. The touch sensitive screen 105 typically includes an active region that can allow for user interaction with one or multiple applications. For example, the active region of the touch sensitive screen 105 may facilitate user interaction with a primary application and, in addition, provide for interaction with a secondary application within a sub-region of the touch sensitive screen 105.

By way of example, the primary region may provide for user interaction with an email application, and the secondary application may provide for user interaction with a contacts application. The secondary application or applications are generally sub-programs or plug-ins of the primary application, but need not necessarily be so. The secondary application is generally presented within the sub-region of the touch sensitive screen 105, such as in an application window 110. It is understood, however, that the term “application window” as used herein may pertain to the primary active region of the touch sensitive screen 105, but typically applies to a sub-region of the touch sensitive screen 105, as is the case for the non-limiting illustrative embodiments described hereinbelow.

The mobile device 100 is shown in FIG. 1 to include a processor 120 and a touch detection module 130. The touch detection module 130 is coupled to the touch sensitive screen 105 and processor 120. The touch detection module 130 includes one or more transducers and detection circuitry configured to sense touches applied to a touch sensitive surface of the touch sensitive screen 105, and typically includes comparator or other processing circuitry to verify contact events as valid touches, such as by comparing sensed touches to a predetermined touch detection threshold or profile. The touch detection module 130 may also be configured to perform calibration routines from time to time, to ensure that valid touches (e.g., short and long taps) are detected and spurious contact events (e.g., palm or thumb grasps, objects laying on the touch sensitive surface) are rejected as invalid touches. Calibration routines may also be performed when touch sensitivity changes due to the presence or build-up of contaminants on the touch sensitive surface of the touch sensitive screen 105.

The processor 120 is programmed to execute program instructions for coordinating operations of the mobile device 100, including the touch sensitive screen 105. The processor 120 coordinates the presentation of text, graphics, icons, etc. on the display 106, which is typically situated below, but can be integrated within, the touch sensitive screen 105. It is noted that the display 106 is typically co-extensive in area with respect to the touch sensitive screen, it being understood that the display 106 may extend beyond the touch sensitive screen. Taps applied to the touch sensitive screen 105 are detected by the touch detection module 130 and touch data is communicated to the processor 120. The processor 120 correlates display indicia/icons (timing and position data) with touch data provided by the touch detection module 130 to interpret a user's input or command. Although shown as separate components, it is understood that functions performed by processor 120 and touch detection module 130 may be performed by a single component or by more than two components.

FIG. 2 is a flow diagram showing various processes implementable by a mobile device that incorporates a touch sensitive screen and a programmed processor for altering user interface functionality based on detected touch characteristics according to an embodiment of the invention. For simplicity, the term “touch sensitive screen” as used herein can interchangeably refer to a separate touch sensitive screen apparatus or a touch sensitive screen apparatus in combination with a display.

According to the embodiment shown in FIG. 2, an application window is presented 200 on the touch sensitive screen. As previously discussed, the application window is typically configured to allow user interaction with a secondary application, while a primary application runs on the active region of the display. The region of the touch sensitive screen within the application window portion of the display facilitates user interaction with the application running in the application window. A typical application window allows a user to search and/or select items of interest, manipulate items and content or metadata associated with items, add or delete items, and perform a variety of functions in response to appropriately applied taps. A typical application window includes one or more buttons and other control icons or features that facilitate user interaction with items and other aspects of the application window.

In accordance with the embodiment illustrated in FIG. 2, the touch sensitive screen and supportive circuitry is configured to detect a long tap. A long tap is preferably defined by a sustained touch applied to the touch sensitive screen that has a duration at least as long as a predetermined ‘long tap’ duration. This duration is preferably defined by the mobile device's software, but may be alterable to suit individual user's rate of device interaction in some embodiments. In general, a long tap may have a duration ranging between about 0.4 seconds and about 1.5 seconds, with a range of about 0.5 to about 1.0 seconds defining a typical long tap duration. For example, a long tap may be activated after the use has pressed an activatable item for about 0.5 seconds.

A long tap may have other attributes that distinguish it from other touch types. For example, a long tap may be defined by attributes including intensity (i.e., firm touch (intentional) vs. soft or glancing touch (unintentional)) and persistence (i.e., a range of intensity sustained over a predetermined duration) in addition to duration. The touch detection circuitry may implement a touch detection algorithm that tests one or more of these and other touch/contact attributes in order to detect a valid long tap and reject spurious touches that may mimic a long tap but are nonetheless unintended long taps.

A long tap detected 202 within the application window preferably results in enabling, initiating, terminating and/or performing predetermined functionality (e.g., altering functionality) within the application window. For example, detection of a long tap within the application window may initiate movement or modify behavior of one or more items presented in the application window in a predetermined manner. Advantageously, a long tap detected 204 outside of the application window preferably results in influencing functionality within the application window, notwithstanding that the long tap was applied by the user outside of the application window.

Application window functionality that is altered in response to a long tap detected within the application window may be the same as, or different from, application window functionality this is altered in response to a long tap detected outside of the application window. In the example provided immediately above, detection of a long tap within the application window may initiate movement or modify behavior of one or more items presented in the application window in a predetermined manner, while detection of a long tap outside of the application window may invoke a ‘view edit’ mode that allows a user to manipulate a selected item within the application window. The ‘view edit’ mode typically allows the user to add, remove, and modify a selected item.

Some embodiments of the invention are directed to solving the problem of how to implement a long tap anywhere on the touch sensitive screen (including the application window) that activates a ‘view edit’ mode, for example, yet still allows for activating or invoking different behaviors within the application window also using a long tap. By way of example, a short tap detected inside the application window would activate one behavior (e.g., ‘move focus’), and a long tap detected at the same or other area inside the application window would not activate the ‘view edit’ mode, but would instead activate a second behavior (e.g., ‘scroll the item list’) if this long tap is detected within a certain timeout. Embodiments of the invention preserve disparate short and long tap functionality within an activation window, and further provide for activation of a ‘view edit’ mode (or other commonly used mode, function) in response to detection of a long tap anywhere on the touch sensitive screen.

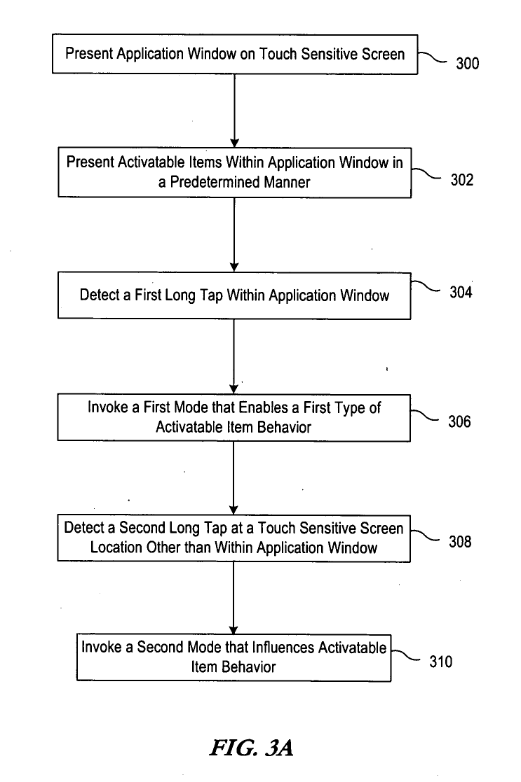

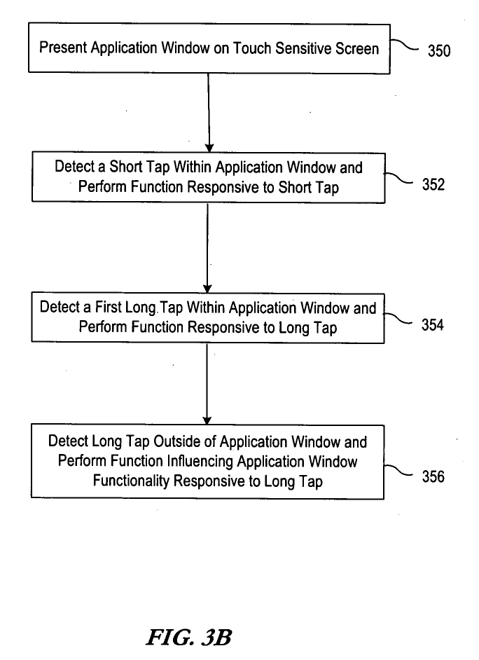

FIG. 3A is a flow diagram showing various processes implementable by a mobile device that incorporates a touch sensitive screen and a programmed processor for altering user interface functionality in response to detecting long taps within and outside of an application window, respectively, according to an embodiment of the invention. According to the embodiment shown in FIG. 3A, an application window is presented 300 on the touch sensitive screen. Invocation of the application window may be user initiated or device initiated. A number of activatable items are presented 302 within the application window in a predetermined manner. An activatable item is an item that can be manipulated in some way by the user, typically after being selected for manipulation by the user.

A first long tap applied within the application window by the user is detected 304. Detection of the first tap results in invocation 306 of a first mode that enables a first type of behavior of an activatable item or items. The behavior may be associated with movement, presentation, functionality, or other aspect of one or more activatable items and/or other features of the activatable window. As is further shown in FIG. 3A, a second long tap is detected 308 at a location of the touch sensitive screen outside of the application window. Detection of the second tap outside of the activation window results in invocation 310 of a second mode that enables a second type of behavior of an activatable item or items within the application window. The second type of behavior may be the same as, or different from, the first type of behavior. Importantly, the second type of behavior is preferably one that enhances a user's efficiency or experience relative to application window functionality. For example, detection of the first long tap 304 and the second long tap 308 may invoke the same function (e.g., ‘view edit’ mode) or may invoked different functions.

FIG. 3B is a flow diagram showing various processes implementable by a mobile device that incorporates a touch sensitive screen and a programmed processor for altering user interface functionality in response to detecting short and long taps within an application window and detecting long taps outside the application window according to an embodiment of the invention. According to the embodiment shown in FIG. 3B, an application window is presented 350 on the touch sensitive screen. The touch sensitive screen and supportive circuitry is configured to detect a short tap and a long tap. A short tap is preferably defined by a sustained touch applied to the touch sensitive screen that has a duration no longer than a predetermined ‘short tap’ duration. This duration is preferably defined by the mobile device's software, but may be alterable to suit individual user's rate of device interaction in some embodiments. In general, a short tap has a duration less than that defined for a long tap. A typical short tap may have a duration of less than about 0.4 seconds, and typically ranges between about 0.1 seconds to about 0.3 seconds. It is to be understood that the long and short tap durations specified herein are for non-limiting illustrative purposes only, and that these durations can be greater or shorter than those specified herein based on application and/or user needs or conditions.

As in the case of a long tap, a short tap may have other attributes that distinguish it from other touch types, such as intensity and persistence. Long and short taps may also be distinguished based on frequency content or power spectral density, with short taps typically having frequency content and power spectral densities higher than that of long taps. Tap signal morphology may also be used to discriminate between short and long taps, such as by comparing touch signal morphological features such as slope and inflection points to a predetermined signal profile or signal parameters. The touch detection circuitry may implement a touch detection algorithm that tests one or more of these and other touch/contact attributes in order to detect a valid long or short tap and reject spurious touches that may mimic a long or short tap.

A short tap detected 352 within the application window preferably results in enabling, initiating, terminating and/or performing predetermined functionality within the application window. For example, detection of a short tap within the application window may initiate incremental movement of one or more items presented in the application window in a predetermined manner. A first long tap detected 354 within the application window preferably results in enabling, initiating, terminating and/or performing predetermined functionality within the application window that differs from that which results from detection of a short tap. For example, detection of a long tap within the application window may initiate continuous (e.g., scrolling) movement or modify behavior of one or more items presented in the application window in a predetermined manner.

A long tap detected 356 outside of the application window preferably results in influencing functionality within the application window, notwithstanding that this long tap was applied by the user outside of the application window. As in the embodiment described above with reference to FIG. 2, application window functionality that is altered in response to a long tap detected within the application window may be the same as, or different from, application window functionality this is altered in response to a long tap detected outside of the application window.

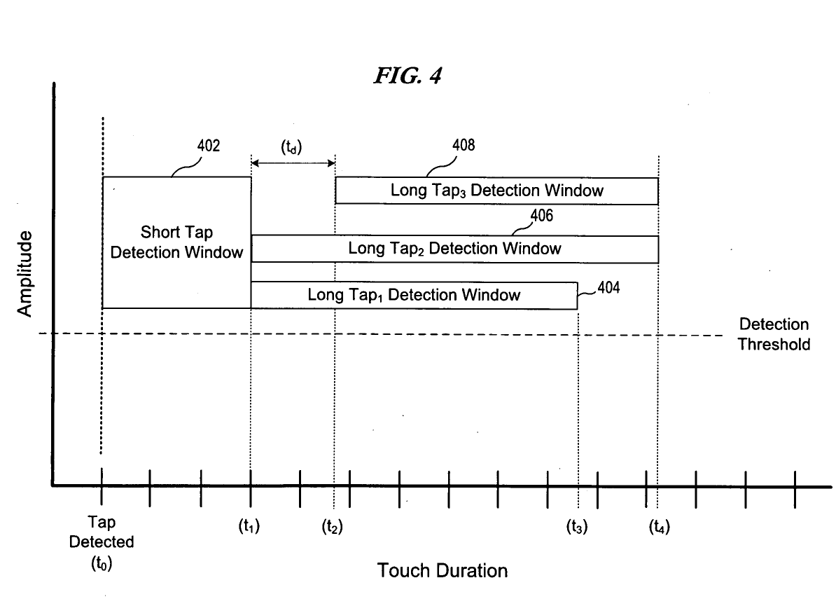

FIG. 4 is a plot of touch duration versus touch signal amplitude and detection windows for detecting long taps within and outside of an application window, respectively, and, optionally, short taps within the application window according to an embodiment of the invention. As was discussed previously, touch duration may be used as the primary basis for discriminating between long taps and other type of touches. In the embodiment shown in FIG. 4, different duration-based methodologies are depicted for detecting long taps. At time t₀, a tap is detected as a touch event that exceeds a predetermined detection threshold. The detection threshold is preferably established to distinguish between intentional taps and unintentional spurious touches or other contact events.

At time t₀, a tap is detected and a timer is started. A short tap detection window 402 is defined between time t₀ and a timer duration that extends to time t₁. A short tap is detected as a touch having an amplitude above the detection threshold and a maximum duration defined by the time period t₁-t₀. In one approach, a touch that has an amplitude above the detection threshold and a duration that exceeds the short tap detection window duration is defined as a long tap. In another approach, a long tap has a touch amplitude above the detection threshold and a duration that exceeds the short tap detection window duration by at least a predetermined amount of time. In yet another approach, a long tap may be defined as having a touch amplitude above the detection threshold and a duration that exceeds the short tap detection window duration by at least a first predetermined amount of time but does not exceed a second predetermined amount of time (i.e., a time-limited long tap detection window, in which continued detection of a touch beyond the time-limited window results in the touch event being ignored).

FIG. 4 shows aspects of various types of approaches for detecting long taps. The touch detection algorithm may be implemented to distinguish between different types of long taps. For example, a first detection window 404 may be used to detect a long tap applied within an application window. A second detection window 406 may be used to detect a long tap applied outside of the application window. The duration of the second detection window 406 may be longer than that of the first detection window 406, which may serve to increase the probability that the user intended to influence application window functionality when applying a touch to the touch sensitive screen outside of the application window.

FIG. 4 shows another detection approach, in which a delay time, t_{d}, separates the short tap window 402 and a long tap detection window 408. This detection approach enhances a user's ability to influence behavior of the application window by use of both short and long taps detected within the application window. A touch having a duration falling within the short tap window 402 preferably results in enabling, initiating, terminating and/or performing predetermined functionality within the application window, as previously described. If a long tap is detected, such as by long tap detection window 408, following a predetermined delay time, t_{d}, then this detected long tap preferably results in enabling, initiating, terminating and/or performing predetermined functionality within the application window that is different from that resulting from detection of a short tap within the application window.

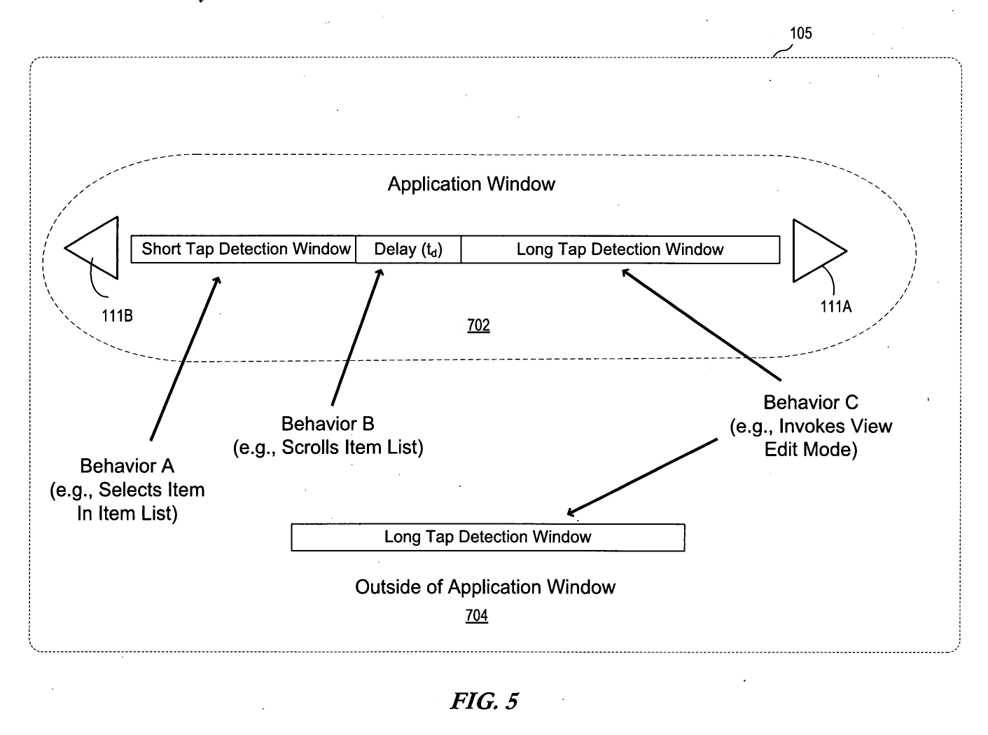

FIG. 5 shows an embodiment of an application window 702 presented on a touch sensitive screen 105 of a mobile device. Touch detection implemented in the application window 702 employs several of the detection techniques discussed above with reference to FIG. 4. In the embodiment shown in FIG. 5, touch sensitive controls 111A, 111B are made available to the user. It is assumed in this illustrative example that a list of items is presented in the application window 702. In response to detecting a short tap above control 111A or 111B, items in the list of items are advanced in a forward or reverse direction in an incremental or step-wise manner. For example, each detected short tap results in advancement of the items one step at a time in a forward or reverse direction depending on which control 111A, 111B is tapped.

Detection of a long tap alters behavior in the application window in different ways depending on when the long tap is detected. For example, and as depicted in FIG. 5, detection of a long tap that occurs after a detected short tap but during a predetermined delay time, t_{d}, following the detected short tap results in scrolling of the items in the item list. Detection of a long tap that occurs after a detected short tap and after the predetermined delay time, t_{d}, following the detected short tap results in invocation of another function, such as ‘view edit’ mode. As is further shown in FIG. 5, detection of a long tap at a location or region 704 outside of the application window 702 results in invocation of a function that influences behavior within the application window 702, such as the ‘view edit’ mode.

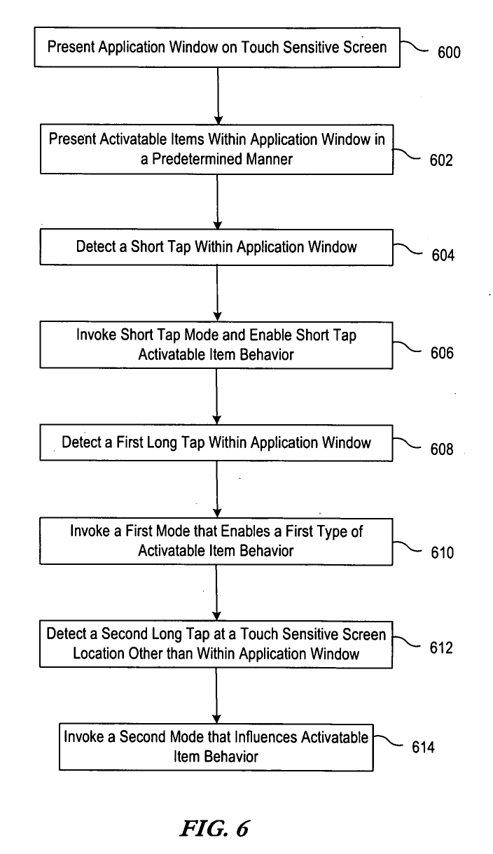

FIG. 6 is a flow diagrams shown various processes for detecting long taps within and outside of an application window, respectively, and short taps within the application window according to another embodiment of the invention. According to the embodiment shown in FIG. 6 an application window is presented 600 on the touch sensitive screen. Invocation of the application window may be user initiated or device initiated. A number of activatable items are presented 602 within the application window in a predetermined manner. In response to detection 604 of a short tap within the application window, a short tap mode is invoked 606 which enables 608 a predetermined type of activatable item behavior responsive to short tap detection.

A first long tap applied within the application window by the user is detected 608, which results in invocation 610 of a first mode that enables a first type of behavior of an activatable item or items within the activatable window. Detection 612 of a second tap outside of the activation window results in invocation 614 of a second mode that enables a second type of behavior of an activatable item or items within the application window. The second type of behavior may be the same as, or different from, the first type of behavior.

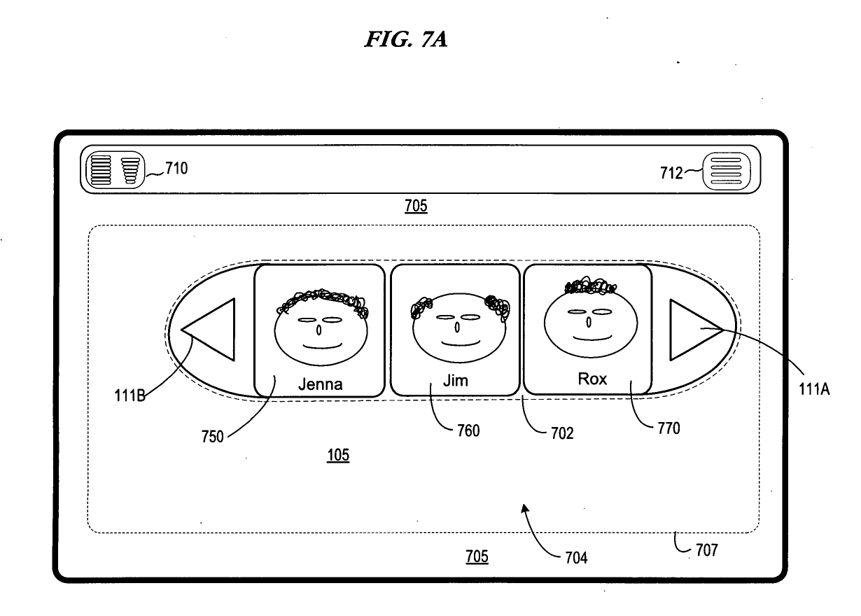

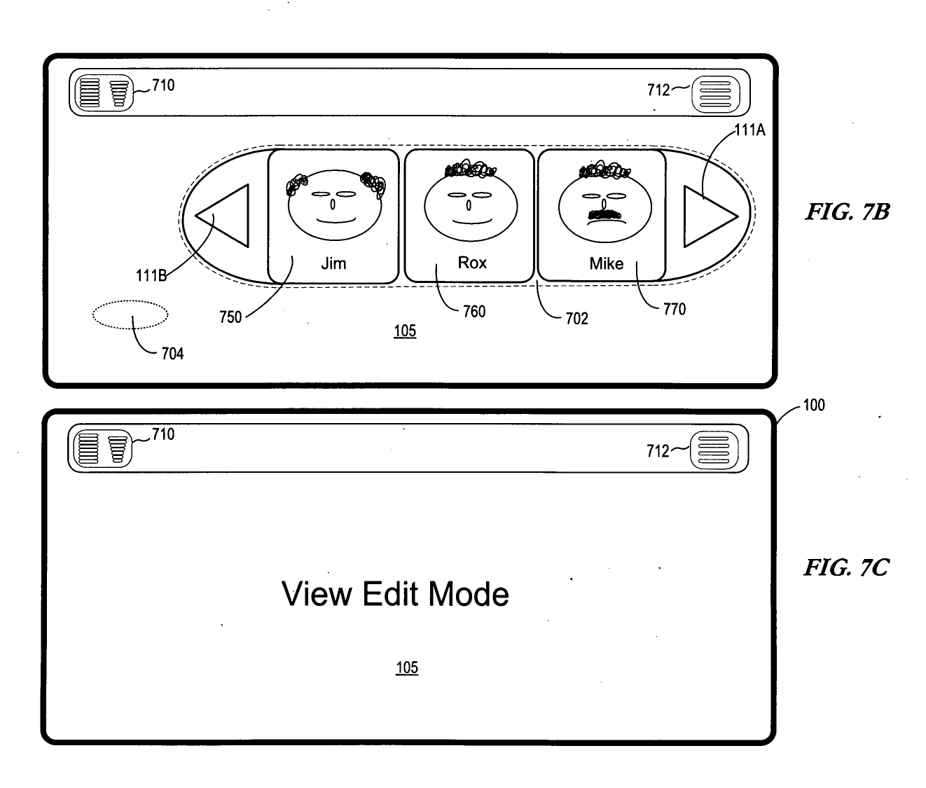

FIGS. 7A-7C illustrate a representative application window presented on a touch sensitive screen and a multiplicity of activatable items that can be selected and/or manipulated in response to detecting different types of taps applied to the application window by a user according to an embodiment of the invention. The touch sensitive screen 105 includes one or more buttons 172 that facilitate various user initiated functions, such as mode changes and the like. One or more status indicators 710 may be presented to provide current device status, such as battery and connection strength indications. The application window 702 in this illustrative example constitutes a widget that comprises a large set of contacts each having associated data, such as name, image, contact information, etc. The widget 702 shown in FIG. 7A presents a subset of the contacts 750, 760, 770 which can be manipulated by user application of taps applied at appropriate location within the widget 702. The contact widget 702 may be useful in a variety of applications, such as email and word processing applications. Widget 702 is of particular use when searching for a certain contact. Typically, the user interacts with the widget 702 to perform a series of single and long taps in both directions in order to find a desired contact.

In many application, it may be desirable to modify some aspect of a widget by a user tap applied outside of the widget. For example, and as depicted in FIGS. 7A-7C, it may be desirable to utilize a design where a long tap applied anywhere on the touch sensitive screen 705, including the widget 702, activates a particular function, such as a ‘view edit’ mode. It is often desirable to have widgets that provide for scrolling or some other functionality that is usually effected with a long tap applied on the widget 702. In this illustrative example, a long tap applied within the widget 702 can invoke two different modes of functionality, while a long tap applied outside 704 of the widget invokes a single function or mode that influences behavior within the widget 702. The touch detection algorithm must therefore distinguish between a long tap within the widget 702 that is intended to effect scrolling of the contacts 750, 760, 770, and a long tap within the widget 702 that is intended to invoke a ‘view edit’ mode.

According to various embodiments of the invention, “intra-widget” long tap discrimination is performed to distinguish between long taps intended to effect a first intended function, such as contact scrolling, and long taps intended to effect a second intended function, such as invoking a ‘view edit’ mode. The following functionality may be implicated in performance of intra-widget long tap discrimination according to an embodiment of the invention. Tapping on a page scroller button 111A, 111B once moves the contact list one step in the selected direction. A long tap (e.g., finger applied over the scroller button 111A, 111B and keeping it pressed down) is performed on the scroller button 111A, 111B which repeats the action, meaning that the contact list continues scrolling as long as there are contacts remaining. This is a very fast and convenient way to scroll long lists of items, such as contacts.

Because the scrolling feature is generally a desired feature, as is the ‘view edit’ mode, intra-widget long tap discrimination is employed to provide for a multiplicity of long tap-initiated functionality. According to one embodiment, the user taps once on a scroller button 111A, 111B which causes the contact list to move one step in the desired direction. The user then performs a long tap on either of the scrollers button 111A, 111B within a certain timeout or delay time (e.g., 2 seconds). This long tap does not activate the ‘view edit’ mode, but instead causes scrolling of the contact list in the desired direction. A long tap applied to an item presented in the widget 702, such as contact 750, invokes the ‘view edit’ mode. Performing a long tap outside the timeout or on any other part of the touch sensitive screen 704 activates the ‘view edit’ mode. In a sense, the user is in a “scroll list slow or fast” mode. This widget interaction and control strategy advantageously supports the normal flow of user interaction with items of the widget, yet provides for enhanced interaction via intra-widget long tap discrimination and extra-widget long tap detection (e.g., the user can advance through a long list sometimes using faster scrolling, sometimes incremental steps, and conveniently invoke a ‘view edit’ mode). It is noted that certain widgets can have enhanced functions by utilizing the timeout even though the long tap would normally be reserved for going to the ‘view edit’ functionality.

Touch sensitive controls 111A, 111B are responsive to short taps and long taps. In response to detecting a short tap above control 111A or 111B, for example, contacts in the contacts list are advanced in a forward or reverse direction in an incremental or step-wise manner depending on which control 111A, 111B is tapped. Detection of a long tap at either of touch sensitive controls 111A, 111B alters behavior in the widget 702 in different ways depending on when the long tap is detected. In this illustrative example, detection of a long tap that occurs after a detected short tap applied at either of touch sensitive controls 111A, 111B, but during a predetermined delay time, t_{d}, following the detected short tap results in forward or reverse scrolling of the contacts in the contact list. Detection of a long tap at either of touch sensitive controls 111A, 111B that occurs after a detected short tap and after the predetermined delay time, t_{d}, following the detected short tap results in invocation of a ‘view edit’ mode, which is depicted in FIG. 7C. As is further shown in FIG. 7B, detection of a long tap at a location or region 704 outside of the application window 702 results in invocation of the ‘view edit’ mode.

It may be desirable to define a first region of the touch sensitive screen 705 outside of the application window or widget 702 that is responsive to long taps for purposes of influencing application window behavior and a second region (or multiple regions) outside of the application window or widget 702 that is not responsive to long taps for purposes of influencing application window behavior. For example, and as shown in FIG. 7A, the region of the touch sensitive screen 705 within the dashed line demarcation 707 may be designated to response to long taps, while the region of the touch sensitive screen 705 peripheral to the dashed line demarcation 707 may be designated to be non-responsive to long taps. This peripheral portion of the touch sensitive screen 705 typically experiences a higher rate of spurious touches (e.g., palm effects, mishandling effects) relative to interior regions. De-sensitizing those regions of the touch sensitive screen 705 that are associated with a higher level of spurious touches can advantageously reduce the likelihood of detecting unintended touches (e.g., long taps) and characterizing such unintended touches as valid taps.

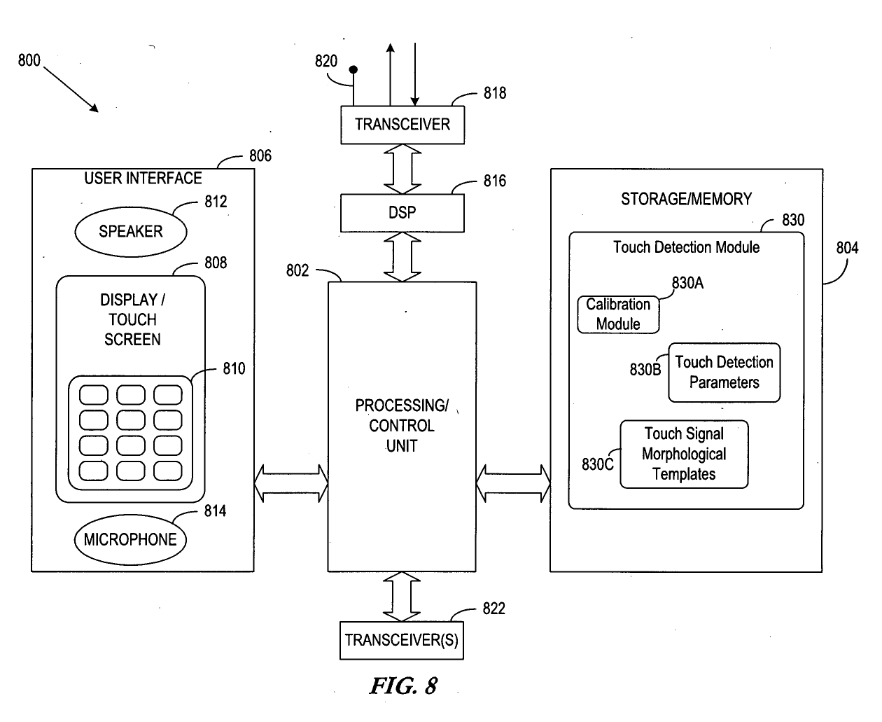

The mobile devices described in connection with the present invention may be represented by any number wireless devices such as wireless/cellular telephones, personal digital assistants (PDAs), or other wireless handsets, as well as portable computing devices capable of facilitating user touch input actuations. The invention is equally applicable to computing and/or communications devices that are not typically considered mobile devices, such as desktop and laptop computing systems. Accordingly, while the description of FIG. 8 below is described in terms of a representative processing arrangement in a mobile communication device such as a mobile phone, the description is equally applicable to other computing/communication devices having analogous or otherwise similar computing modules and/or circuitry. The mobile or other devices utilize computing systems to control and manage the conventional device activity as well as the functionality provided by the present invention. Hardware, firmware, software or any combination thereof may be used to perform the various functions and operations described herein. An example of a representative mobile device computing system capable of carrying out operations in accordance with the invention is illustrated in FIG. 8. As indicated above, analogous or otherwise similar components and modules may be used in embodiments involving other computing and/or communication devices.

The exemplary mobile computing arrangement 800 suitable for performing the touch detection and application window processing features of the present invention is a mobile phone or other mobile communication device. The exemplary device includes a processing/control unit 802, such as a microprocessor, reduced instruction set computer (RISC), or other central processing module. The processing unit 802 need not be a single device, and may include one or more processors. For example, the processing unit may include a master processor and one or more associated slave processors coupled to communicate with the master processor.

The processing unit 802 controls the basic functions of the mobile device as dictated by programs available in the program storage/memory 804. The processing unit 802 executes functions associated with at least the detection of various types of taps applied to a touch sensitive user interface for controlling functionality of an application window or widget. More particularly, the program storage/memory 804 may include an operating system and program modules for carrying out functions and applications on the mobile device. For example, the program storage may include one or more of read-only memory (ROM), flash ROM, programmable and/or erasable ROM, random access memory (RAM), subscriber interface module (SIM), wireless interface module (WIM), smart card, disk, CD-ROM, DVD, or other resident or removable memory device. The agent(s) or other software operable with the processing unit 802 to perform functions in accordance with the invention may also be transmitted to the mobile computing arrangement 800 via data signals, such as being downloaded electronically via a network, such as the Internet. Such information may also be provided to the mobile (or non-mobile) computing arrangement via wired links.

The representative processor 802 is coupled to user-interface 806 elements associated with the mobile device. The user-interface 806 of the mobile device may include, for example, a display 808 such as a liquid crystal display, a touch sensitive surface and associated detection circuitry, a keypad 810 which may be touch sensitive keypad, speaker 812, and microphone 814. These and other user-interface components are coupled to the processor 802 as is known in the art. The exemplary keypad 810 may include alpha-numeric touch sensitive keys for performing a variety of functions, including dialing numbers and executing operations assigned to one or more keys. Alternatively, other user-interface mechanisms may be employed, such as voice commands, switches, graphical user interface using a pointing device, trackball, joystick, and/or any other user interface mechanism.

The mobile computing arrangement 800 may also include a digital signal processor (DSP) 816. The DSP 816 may perform a variety of functions, including analog-to-digital (A/D) conversion, digital-to-analog (D/A) conversion, speech coding/decoding, encryption/decryption, error detection and correction, bit stream translation, filtering, etc. The transceiver 818, generally coupled to an antenna 820, transmits and receives the radio signals associated with the wireless device in the case of mobile voice and/or data communications. The computing arrangement 800 may also include a transceiver or other interface 822 for GPS or other positioning technology communication.

The program storage/memory 804 stores various client programs, and data where applicable, used in connection with the present invention. The program storage/memory may include one or more modules 830 to process touch signals received from the touch sensitive screen 808. Examples of such modules 830 include a calibration module 830A, a module 830B for storing touch detection parameters such as detection window and time delay parameters, and a module 830C for storing morphological templates for analyzing and characterizing sensed touch signals when using a morphological detection approach.

These and other modules may be separate modules operable in connection with the processor 802, may be a single module performing each of these functions, or may include a plurality of such modules performing the various functions. In other words, while the modules are shown as multiple software/firmware modules, these modules may or may not reside in the same software/firmware program. It should also be recognized that one or more of these functions may be performed via hardware. These modules are representative of the types of functional and data modules that may be associated with a mobile device in accordance with the invention, and are not intended to represent an exhaustive list. Also, other functions not specifically shown but otherwise described herein may be implemented by the processor 802.

The mobile computing arrangement 800 of FIG. 8 is provided as a representative example of a computing environment in which the principles of the present invention may be applied. From the description provided herein, those skilled in the art will appreciate that the present invention is equally applicable in a variety of other currently known and future mobile computing environments. For example, the programs and/or data may be stored in a variety of manners, may be operable on a variety of processing devices, and may be operable in mobile devices having additional, fewer, or different supporting circuitry and user-interface mechanisms.

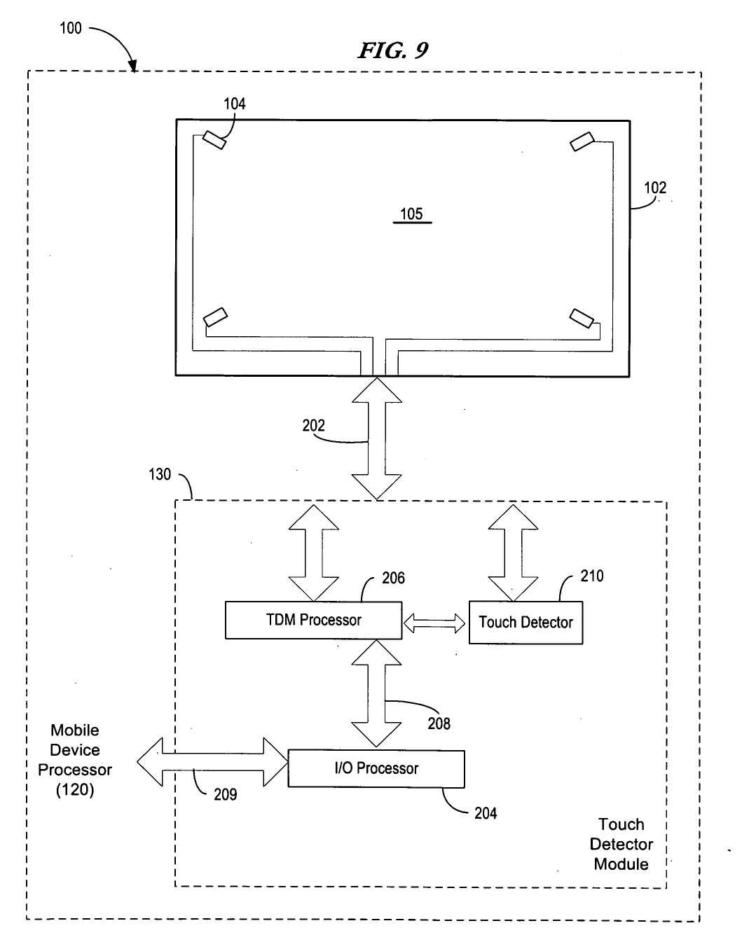

FIG. 9 shows a portion of a mobile device 100 of the present invention that incorporates a touch detector module 130 communicatively coupled to a touch screen 105. Touch detector module 130 is typically incorporated in a touch input device that also includes touch screen 105, although some or all elements of touch detector module 130 can be incorporated external of the touch panel housing if desired in a particular design. An interface 202 communicatively couples the touch screen 105 to touch detector module 130. Touch detector module 130 includes a TDM processor 206 and touch detector 210. According to the configuration shown in FIG. 9, touch detector 210 is coupled to the TDM processor 206 and interface 202.

In this configuration, the TDM processor 206 is responsible for performing touch location computations, calibration, and other related functions. TDM processor 206 also manages signal transmission between the touch screen 105 and touch detector module 130 via interface 202, and between the touch detector module 130 and other circuitry of the mobile device 100 via bus 209 (e.g., processor 120 shown in FIG. 1). TDM processor 206 preferably incorporates a digital signal processor (DSP). Bus 209 may communicatively couple TDM processor 206 with processor 120 (shown in FIG. 1), although one, some or all of TDM processor 206, touch detector 210, and I/O processor 204 may be incorporated in a single processor, such as processor 120 of FIG. 1. Touch detector 210 is shown coupled to interface 202 for purposes of sensing touch input signals generated by the sensors 104 and detecting short and long taps in accordance with one or more techniques previously described. The sensors 104 may be of various technology based on the type of touch screen technology employed in the touch sensor. Popular sensors include piezoelectric sensors, electrostrictive sensors, magnetostrictive sensors, piezoresistive sensors, acoustic sensors, and moving coil devices, among others.

The signals communicated from the touch screen 105 to the touch detector module 130 are typically analog current signals produced by the touch sensors 104, it being understood that the analog current signals can be converted to analog or digital voltage signals by circuitry provided between the touch screen 105 and touch detector module 130 or by circuitry of TDM processor 206. Excitation signals can also be communicated from touch detector module 130 to the touch screen 105 in cases where one or more emitters or emitters/sensors are provided on the substrate 102 of the touch screen 105.

Using the description provided herein, the invention may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the invention. As such, the terms “computer program product,” “modules,” and the like as used herein are intended to encompass a computing device-executable program(s) that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links.

From the description provided herein, those skilled in the art are readily able to combine software created as described with appropriate general purpose or special purpose computer hardware to create a mobile computer system(s) and/or computer subcomponents embodying the invention, and to create a mobile computer system and/or computer subcomponents for carrying out the method(s) of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is not intended that the scope of the invention be limited with this detailed description, but rather determined in view of what would be apparent to those skilled in the art from the description provided herein and the claims appended hereto.

What is claimed is:

1. A method comprising:
presenting an application window on a touch sensitive screen provided on a mobile device, the application window configured to facilitate user interaction with an application and with a plurality of touch activatable items displayable in a predetermined manner within the application window;
detecting a first long tap having a first predetermined duration within the application window;
invoking, in response to detecting the first long tap, a first mode of the application window that enables a first type of behavior of one or more of the touch activatable items;
detecting, at a touch sensitive screen location other than a location within the application window, a second long tap having a second predetermined duration; and
invoking, in response to the second long tap, a second mode that influences behavior of one or more of the touch activatable items within the application window.

2. The method of claim 1, wherein the first mode enables movement of one or more of the activatable items in a predetermined manner in response to detecting each of the first long taps.

3. The method of claim 1, wherein the first mode enables scrolling movement of one or more of the activatable items in response to detecting each of the first long taps.

4. The method of claim 1, wherein the first mode enables opening the item to enable modification of the item in response to detecting each of the first long taps.

5. The method of claim 1, wherein the second mode influences behavior of one or more of the touch activatable items within the application window in a manner differing from the first type of behavior.

6. The method of claim 1, wherein the second mode influences behavior of one or more of the touch activatable items within the application window in a manner substantially similar to the first type of behavior.

7. The method of claim 1, wherein the second mode enables opening the item to enable modification of the item in response to detecting each of the second long taps.

8. The method of claim 1, comprising:
detecting a tap within the application window;
identifying the tap as a short tap in response to determining that the tap has a duration shorter than the predetermined duration of the first long tap; and
invoking, in response to detecting the short tap, a third mode that enables a third type of behavior of one or more of the touch activatable items.

9. The method of claim 1, wherein:
the third mode enables movement of one or more of the activatable items in an incremental manner in response to detecting each of the short taps; and
the first mode enables movement of one or more of the activatable items in a continuous manner in response to detecting each of the first long taps within a predetermined delay period.

10. The method of claim 1, wherein
the touch sensitive screen is configured to respond to a short tap within the application window, the short tap having a predetermined duration shorter than the first predetermined duration of the first long tap;
the application window comprises at least one touch sensitive control configured to control behavior of the one or more activatable items within the application window;
detecting the short tap at the touch sensitive control activates the third mode; and
detecting the first long tap at the touch sensitive control activates the first mode.

11. A user interface, comprising:
a touch sensitive screen;
a touch detection module coupled to the touch sensitive screen and configured to detect a touch applied to the touch sensitive screen and determine a location of the touch the touch sensitive screen, the touch detection module configured to detect a first long tap within an application window of the touch sensitive screen having a first predetermined duration and detect, at a touch sensitive screen location other than a location within the application window, a second long tap having a second predetermined duration; and
a processor coupled to the user interface and the touch detection module, the processor configured to:
display a plurality of touch activatable items associated with a processor controlled application in a predetermined manner within the application window;
activate, in response to the touch detection module detecting the first long tap, a first mode of the application window that enables a first type of behavior of one or more of the touch activatable items; and
activate, in response to the touch detection module detecting the second long tap, a second mode that influences behavior of one or more of the touch activatable items within the application window.

12. The user interface of claim 11, wherein the first mode enables movement of one or more of the activatable items in a predetermined manner in response to detecting each of the first long taps.

13. The user interface of claim 11, wherein the first mode enables scrolling movement of one or more of the activatable items in response to detecting each of the first long taps.

14. The user interface of claim 11, wherein the first mode enables opening the item to enable user modification of the item in response to detecting each of the first long taps.

15. The user interface of claim 11, wherein the second mode influences behavior of one or more of the touch activatable items within the application window in a manner differing from the first type of behavior.

16. The user interface of claim 11, wherein the second mode influences behavior of one or more of the touch activatable items within the application window in a manner substantially similar to the first type of behavior.

17. The user interface of claim 11, wherein the processor is configured to:
detect a tap within the application window;
identify the tap as a short tap in response to determining that the tap has a duration shorter than the predetermined duration of the first long tap; and
activate, in response to detecting the short tap, a third mode that enables a third type of behavior of one or more of the touch activatable items.

18. The user interface of claim 11, wherein:
in the third mode, the processor is configured to enable movement of one or more of the activatable items in an incremental manner in response to the touch detection module detecting each of the short taps; and
in the first mode, the processor is configured to enable movement of one or more of the activatable items in a continuous manner in response to the touch detection module detecting each of the first long taps within a predetermined delay period.

19. The user interface of claim 11, wherein:
the application window comprises at least one touch sensitive control configured to control behavior of the one or more activatable items within the application window;
the touch detection module is configured to detect the short tap at the touch sensitive control; and
the processor is configured to activate the third mode in response to the touch detection module detecting the short tap and activate the first mode in response to the touch detection module detecting the first long tap at the touch sensitive control.

20. An apparatus incorporating or arranged to incorporate a user interface according to claim 11.

21. An apparatus, comprising:
means for presenting an application window on a touch sensitive screen, the application window configured to facilitate user interaction with an application and with a plurality of touch activatable items displayable in a predetermined manner within the application window;
means for detecting a first long tap having a first predetermined duration within the application window;
means for invoking, in response to detecting the first long tap, a first mode of the application window that enables a first type of behavior of one or more of the touch activatable items;
means for detecting, at a touch sensitive screen location other than a location within the application window, a second long tap having a second predetermined duration; and means for invoking, in response to the second long tap, a second mode that influences behavior of one or more of the touch activatable items within the application window.

22. A computer-readable storage medium having instructions executable by a processor for performing steps comprising:
presenting an application window on a touch sensitive screen provided on a mobile device, the application window configured to facilitate user interaction with an application and with a plurality of touch activatable items displayable in a predetermined manner within the application window;
detecting a first long tap having a first predetermined duration within the application window;
invoking, in response to detecting the first long tap, a first mode of the application window that enables a first type of behavior of one or more of the touch activatable items;
detecting, at a touch sensitive screen location other than a location within the application window, a second long tap having a second predetermined duration; and
invoking, in response to the second long tap, a second mode that influences behavior of one or more of the touch activatable items within the application window.
